(19) United States
(12) Patent Application Publication
(10) Pub. No.: US 2025/0159713 A1
(43) Pub. Date: May 15, 2025

(54) IRREGULAR CYCLIC PREFIX LENGTHS FOR DOWNLINK TRANSMISSION

(71) Applicant: QUALCOMM Incorporated, San Diego, CA (US)

(72) Inventors: Shay LANDIS, Hod Hasharon (IL); Idan Michael HORN, Hod Hasharon (IL); David YUNUSOV, Holon (IL)

(21) Appl. No.: 18/506,361

(22) Filed: Nov. 10, 2023

(51) Int. Cl. H04W 72/541; H04W 72/0446; H04W 76/10

(52) U.S. Cl. CPC H04W 72/541; H04W 72/0446; H04W 76/10

(57) ABSTRACT

Methods, systems, and devices for wireless communications are described. The described techniques may enable a network entity to apply an irregular (e.g., non-uniform) cyclic prefix (CP) to symbols of a slot for a downlink transmission to a user equipment (UE). In some examples, the UE or the network entity may measure one or more reference signals to estimate a channel impulse response (CIR) and therefore calculate a relatively small CP length for physical downlink shared channel (PDSCH) transmissions. The network entity may use the relatively small CP length for one or more symbols of a first symbol group dedicated for PDSCH transmissions, and may use a longer CP length for one or more symbols of an additional symbol group dedicated for other transmissions (e.g., to allow the network entity to configure beam changes in each symbol in the additional symbol group).

### FIELD OF TECHNOLOGY

The following relates to wireless communications, including irregular cyclic prefix lengths for downlink transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support irregular cyclic prefix lengths for downlink transmission. For example, the described techniques provide for a network entity to apply an irregular (e.g., non-uniform) cyclic prefix (CP) to symbols of a slot for a downlink transmission to a user equipment (UE). In some examples, the UE or the network entity may measure one or more reference signals to estimate a channel impulse response (CIR) and therefore calculate a relatively small CP length for physical downlink shared channel (PDSCH) transmissions. The network entity may use the relatively small CP length for one or more symbols of a first symbol group dedicated for PDSCH transmissions, and may use a longer CP length for one or more symbols of an additional symbol group dedicated for other transmissions (e.g., to allow the network entity to configure beam changes in each symbol in the additional symbol group).

A method for wireless communications by a UE is described. The method may include establishing a connection with a network entity, receiving control information indicating that a set of multiple symbols of a slot used for communication of a downlink message are associated with non-uniform CP lengths, and receiving the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

A UE for wireless communications is described. The UE may include one or more memories storing processor-executable code, and one or more processors coupled with the one or more memories. The one or more processors may individually or collectively operable to execute the code to cause the UE to establish a connection with a network entity, receive control information indicating that a set of multiple symbols of a slot used for communication of a downlink message are associated with non-uniform CP lengths, and receive the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

Another UE for wireless communications is described. The UE may include means for establishing a connection with a network entity, means for receiving control information indicating that a set of multiple symbols of a slot used for communication of a downlink message are associated with non-uniform CP lengths, and means for receiving the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

A non-transitory computer-readable medium storing code for wireless communications is described. The code may include instructions executable by a processor to establish a connection with a network entity, receive control information indicating that a set of multiple symbols of a slot used for communication of a downlink message are associated with non-uniform CP lengths, and receive the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

Some examples of the method, UEs, and non-transitory computer-readable medium described herein may further include operations, features, means, or instructions for measuring one or more channel state information reference signals (CSI-RSs) via a channel between the UE and the network entity and calculating, based on the measuring, a CP length for the downlink message associated with a CIR of the channel between the UE and the network entity.

Some examples of the method, UEs, and non-transitory computer-readable medium described herein may further include operations, features, means, or instructions for transmitting one or more sounding reference signals (SRSs) via a channel between the UE and the network entity and receiving, from the network entity, an indication of a CP length for the downlink message associated with a channel impulse response (CIR) of the channel between the UE and the network entity.

In some examples of the method, UEs, and non-transitory computer-readable medium described herein, receiving the control information may include operations, features, means, or instructions for receiving a radio resource control (RRC) message indicating one or more non-uniform CP templates, where each of the one or more non-uniform CP templates may be associated with a respective slot configuration of a set of multiple slot configurations.

Some examples of the method, UEs, and non-transitory computer-readable medium described herein may further include operations, features, means, or instructions for receiving a control message indicating a non-uniform CP template of the one or more non-uniform CP templates.

In some examples of the method, UEs, and non-transitory computer-readable medium described herein, the control message may be a medium access control control element (MAC-CE) or a downlink control information (DCI) message.

In some examples of the method, UEs, and non-transitory computer-readable medium described herein, the set of multiple slot configurations includes a slot including one or more PDSCH symbols and one or more CSI-RS symbols, a slot including one or more PDSCH symbols and one or more synchronization signal block (SSB) symbols, a slot including one or more CSI-RS symbols and one or more SSB symbols, a special slot, or some combination thereof.

In some examples of the method, UEs, and non-transitory computer-readable medium described herein, receiving the control information may include operations, features, means, or instructions for receiving a control message indicating a set of multiple symbol groups of the slot, where the first symbol may be in a first symbol group of the set of multiple symbol groups and where the second symbol may be in a second symbol group of the set of multiple symbol groups.

In some examples of the method, UEs, and non-transitory computer-readable medium described herein, receiving the control information may include operations, features, means, or instructions for RRC message indicating a set of multiple CP length patterns, where the control message indicates a CP length pattern of the set of multiple CP length patterns.

In some examples of the method, UEs, and non-transitory computer-readable medium described herein, the first symbol may be a PDSCH symbol and the second symbol may be one of a CSI-RS symbol or a SSB symbol.

In some examples of the method, UEs, and non-transitory computer-readable medium described herein, a length of the second CP may be based on a beam configuration time for one or more CSI-RSs.

In some examples of the method, UEs, and non-transitory computer-readable medium described herein, an initial symbol of the slot may be associated with a longer CP than the first symbol and a length of the initial symbol may be based on a beam configuration time for one or more PDSCH transmissions.

In some examples of the method, UEs, and non-transitory computer-readable medium described herein, the UE may be configured to increase a CP length based on the first symbol being associated with a first transmission type and the second symbol being associated with a second transmission type.

A method for wireless communications by a network entity is described. The method may include establishing a connection with a UE, transmitting control information indicating that a set of multiple symbols of a slot used for communication of a downlink message are associated with non-uniform CP lengths, and transmitting the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

A network entity for wireless communications is described. The network entity may include one or more memories storing processor executable code, and one or more processors coupled with the one or more memories. The one or more processors may individually or collectively operable to execute the code to cause the network entity to establish a connection with a UE, transmit control information indicating that a set of multiple symbols of a slot used for communication of a downlink message are associated with non-uniform CP lengths, and transmit the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

Another network entity for wireless communications is described. The network entity may include means for establishing a connection with a UE, means for transmitting control information indicating that a set of multiple symbols of a slot used for communication of a downlink message are associated with non-uniform CP lengths, and means for transmitting the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

A non-transitory computer-readable medium storing code for wireless communications is described. The code may include instructions executable by a processor to establish a connection with a UE, transmit control information indicating that a set of multiple symbols of a slot used for communication of a downlink message are associated with non-uniform CP lengths, and transmit the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

Some examples of the method, network entities, and non-transitory computer-readable medium described herein may further include operations, features, means, or instructions for transmitting one or more CSI-RSs via a channel between the UE and the network entity and receiving, from the UE, a CP length for the downlink message associated with a CIR of the channel between the UE and the network entity.

Some examples of the method, network entities, and non-transitory computer-readable medium described herein may further include operations, features, means, or instructions for measuring one or more SRSs via a channel between the UE and the network entity and calculating, based on the measuring, an indication of a CP length for the downlink message associated with a CIR of the channel between the UE and the network entity.

In some examples of the method, network entities, and non-transitory computer-readable medium described herein, transmitting the control information may include operations, features, means, or instructions for transmitting a radio resource control message indicating one or more non-uniform CP templates, where each of the one or more non-uniform CP templates may be associated with a respective slot configuration of a set of multiple slot configurations.

In some examples of the method, network entities, and non-transitory computer-readable medium described herein, transmitting the control information may include operations, features, means, or instructions for transmitting a control message indicating a non-uniform CP template of the one or more non-uniform CP templates.

In some examples of the method, network entities, and non-transitory computer-readable medium described herein, the control message may be a MAC-CE or a DCI message.

In some examples of the method, network entities, and non-transitory computer-readable medium described herein, the set of multiple slot configurations includes a slot including one or more PDSCH symbols and one or more CSI-RS symbols, a slot including one or more PDSCH symbols and one or more SSB symbols, a slot including one or more CSI-RS symbols and one or more SSB symbols, a special slot, or some combination thereof.

In some examples of the method, network entities, and non-transitory computer-readable medium described herein, transmitting the control information may include operations, features, means, or instructions for transmitting a control message indicating a set of multiple symbol groups of the slot, where the first symbol may be in a first symbol group of the set of multiple symbol groups and where the second symbol may be in a second symbol group of the set of multiple symbol groups.

In some examples of the method, network entities, and non-transitory computer-readable medium described herein, transmitting the control information may include operations, features, means, or instructions for transmitting a radio resource control message indicating a set of multiple CP length patterns, where the control message indicates a CP length pattern of the set of multiple CP length patterns.

In some examples of the method, network entities, and non-transitory computer-readable medium described herein, the first symbol may be a PDSCH symbol and the second symbol may be one of a CSI-RS symbol or a SSB symbol.

In some examples of the method, network entities, and non-transitory computer-readable medium described herein, a length of the second CP may be based on a beam configuration time for one or more CSI-RSs.

In some examples of the method, network entities, and non-transitory computer-readable medium described herein, an initial symbol of the slot may be associated with a longer CP than the first symbol and a length of the initial symbol may be based on a beam configuration time for one or more PDSCH transmissions.

In some examples of the method, network entities, and non-transitory computer-readable medium described herein, the network entity may be configured to increase a CP length based on the first symbol being associated with a first transmission type and the second symbol being associated with a second transmission type.

### BRIEF DESCRIPTION OF THE DRAWINGS

FIG. 1 shows an example of a wireless communications system that supports irregular cyclic prefix (CP) lengths for downlink transmission in accordance with one or more aspects of the present disclosure.

FIG. 2 shows an example of a wireless communications system that supports irregular CP lengths for downlink transmission in accordance with one or more aspects of the present disclosure.

FIG. 3 shows an example of a slot diagram that supports irregular CP lengths for downlink transmission in accordance with one or more aspects of the present disclosure.

FIG. 4 shows an example of a process flow that supports irregular CP lengths for downlink transmission in accordance with one or more aspects of the present disclosure.

FIGS. 5 and 6 show block diagrams of devices that support irregular CP lengths for downlink transmission in accordance with one or more aspects of the present disclosure.

FIG. 7 shows a block diagram of a communications manager that supports irregular CP lengths for downlink transmission in accordance with one or more aspects of the present disclosure.

FIG. 8 shows a diagram of a system including a device that supports irregular CP lengths for downlink transmission in accordance with one or more aspects of the present disclosure.

FIGS. 9 and 10 show block diagrams of devices that support irregular CP lengths for downlink transmission in accordance with one or more aspects of the present disclosure.

FIG. 11 shows a block diagram of a communications manager that supports irregular CP lengths for downlink transmission in accordance with one or more aspects of the present disclosure.

FIG. 12 shows a diagram of a system including a device that supports irregular CP lengths for downlink transmission in accordance with one or more aspects of the present disclosure.

FIGS. 13 through 18 show flowcharts illustrating methods that support irregular CP lengths for downlink transmission in accordance with one or more aspects of the present disclosure.

### DETAILED DESCRIPTION

In some wireless communications systems, a user equipment (UE) may receive downlink transmissions from a network entity in a slot including multiple symbols. In some examples, transmissions in each symbol may experience inter-symbol interference (ISI) from transmissions in neighboring symbols. Accordingly, the network entity may use a cyclic prefix (CP) in each symbol to add a guard period between symbols to decrease ISI. In some examples, if a length of the CP is longer than a channel impulse response (CIR), ISI may be further decreased (e.g., completely suppressed). However, using relatively longer CP lengths may increase an overhead associated with the downlink transmissions (e.g., as compared to relatively shorter CP lengths). Further, sub-terahertz (THz) frequency bands may have a lower CIR than some other frequency bands, and thus a shorter CP length may be sufficient. Such shorter CP lengths may decrease an overhead associated with the transmissions (e.g., without increasing ISI). However, to transmit some types of signals (e.g., channel state information (CSI) reference signals (RSs) or synchronization signal blocks (SSBs)), the network entity may change beam configurations in each symbol, and therefore the shorter CP length may be insufficient to account for a beam switching delay.

Accordingly, techniques described herein may enable the network entity to apply an irregular (e.g., non-uniform) CP to symbols of a slot. In some examples, the UE or the network entity may measure one or more reference signals (e.g., CSI-RSs or sounding reference signals (SRSs)) to estimate a CIR and therefore calculate a relatively small (e.g., minimum) CP length for physical downlink shared channel (PDSCH) transmissions (e.g., when compared to a normal CP). The network entity may use the relatively small CP length for one or more symbols of a first symbol group dedicated for PDSCH transmissions, and may use a longer CP length for one or more symbols of an additional symbol group dedicated for other transmissions (CSI-RSs, SSBs, etc.) to allow the network entity to configure beam changes in each symbol in the additional symbol group.

In some examples, the UE and the network entity may be configured with one or more non-uniform CP length templates associated with a type of slot (e.g., a slot for some combination of SSB, PDSCH, or CSI-RS). Additionally, or alternatively, the UE and the network entity may be configured with one or more CP length patterns for a slot. The network entity may indicate one of the CP length templates or patterns to the UE (e.g., via downlink control information (DCI) or a medium access control-control element (MAC-CE)). In some examples, the network entity may indicate one or more sets of symbols of a slot that may share a same CP length.

Aspects of the disclosure are initially described in the context of wireless communications systems. Aspects of the disclosure are further illustrated by and described with reference to slot diagrams and process flow diagrams. Aspects of the disclosure are further illustrated by and described with reference to apparatus diagrams, system diagrams, and flowcharts that relate to irregular CP lengths for downlink transmission.

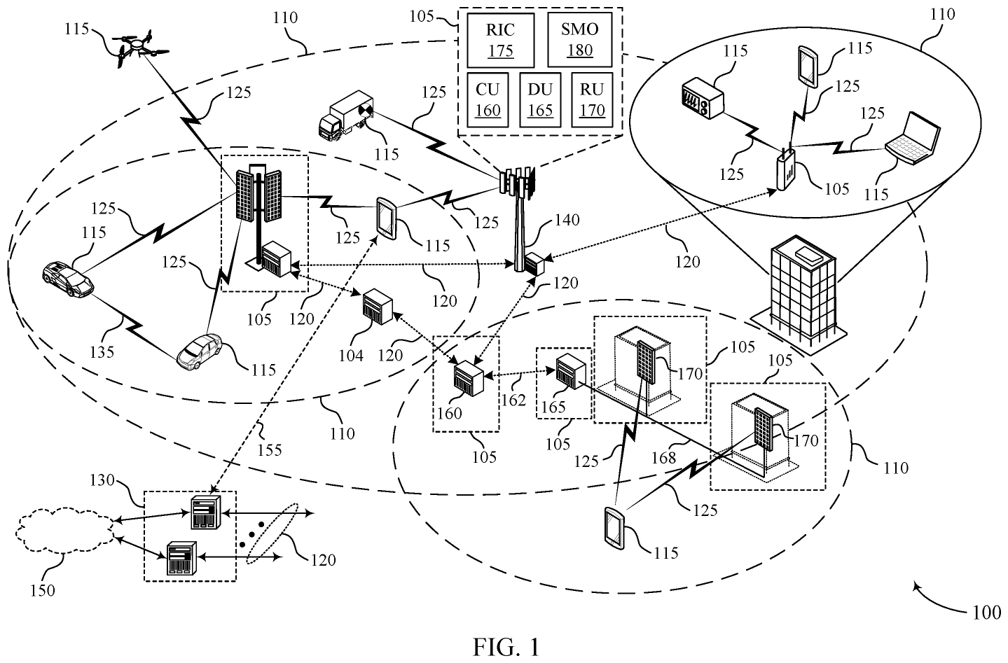

FIG. 1 shows an example of a wireless communications system 100 that supports irregular CP lengths for downlink transmission in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support irregular CP lengths for downlink transmission as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a CP. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the CP prepended to each symbol period). In some wireless communications systems 100, a slot may further be divided into multiple mini-slots associated with one or more symbols. Excluding the CP, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Techniques described herein may enable a network entity 105 to apply an irregular (e.g., non-uniform) CP to symbols of a slot for a downlink transmission to a UE 115. In some examples, the UE 115 or the network entity 105 may measure one or more reference signals (e.g., CSI-RSs or SRSs) to estimate a CIR and thereby calculate a relatively small (e.g., minimum) CP length for PDSCH transmissions (e.g., as compared to a normal CP length). The network entity 105 may use the relatively small CP length for one or more symbols of a first symbol group dedicated for PDSCH transmissions, and may use a longer CP length for one or more symbols of an additional symbol group dedicated for other transmissions (CSI-RSs, SSBs, etc.) to allow the network entity 105 to configure beam changes in each symbol in the additional symbol group.

In some examples, the UE 115 and the network entity 105 may be configured with one or more non-uniform CP length templates associated with a type of slot (e.g., a slot for some combination of SSB, PDSCH, or CSI-RS). Additionally, or alternatively, the UE 115 and the network entity 105 may be configured with one or more CP length patterns (e.g., one or more sets of symbols of a slot that may share a same CP length) for a slot. The network entity 105 may indicate one of the CP length templates or patterns to the UE 115 (e.g., via DCI or MAC-CE). In some examples, the CP length templates may be associated with a slot configuration. For example, the UE 115 and the network entity 105 may be configured with a first CP length template for a slot comprising CSI-RS symbols and PDSCH symbols, a second CP length template for a slot comprising CSI-RS symbols and SSB symbols, a third CP length template for a slot comprising PDSCH symbols and SSB symbols, and so on.

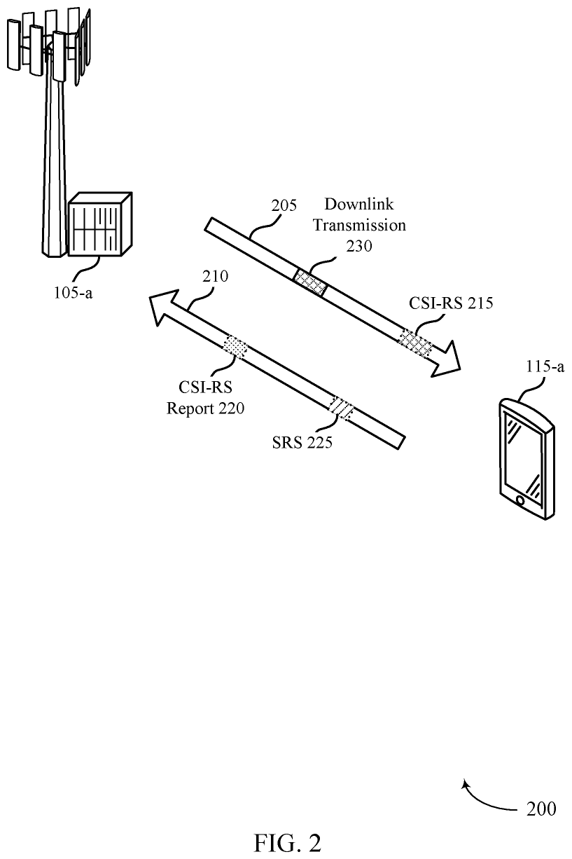

FIG. 2 shows an example of a wireless communications system 200 that supports irregular CP lengths for downlink transmission in accordance with one or more aspects of the present disclosure. The wireless communications system 200 may implement or may be implemented by aspects of the wireless communications system 100. For example, the wireless communications system 200 may include a UE 115 (e.g., a UE 115-a) and a network entity 105 (e.g., a network entity 105-a), which may be examples of the corresponding devices as described herein with reference to FIG. 1.

In some examples of the wireless communications system 200, a network entity 105-a may transmit one or more signals to a UE 115-a via a downlink channel 205. For example, the network entity 105-a may transmit one or more downlink transmissions 230 (e.g., downlink data messages such as PDSCH messages or physical downlink control channel (PDCCH) messages or reference signals such as CSI-RSs) via the downlink channel. The UE 115-a may transmit one or more signals to the network entity 105-a via an uplink channel 210.

To reduce ISI between symbols of a slot used for downlink transmissions 230, the network entity 105-a may use a CP at the beginning of each symbol. For example, the CP may add a guard period between orthogonal frequency division multiplexed (OFDM) symbols of the slot. In some examples (e.g., if a length of the CP is greater than a duration of a CIR of the downlink channel 205), ISI may be further reduced (e.g., completely suppressed). Accordingly, a CP may be designed to cover a relatively long (e.g., worst-case expected) CIR. However, longer CP lengths (e.g., extended CP) may increase an overhead associated with the downlink transmissions 230 as compared to other CP lengths (e.g., normal CP), and the network entity 105-a may therefore use a normal CP rather than an extended CP in most cases. Table 1 provides an illustrative example of overhead associated with CP for symbols of different numerologies and subcarrier spacings (SCSs).

TABLE 1

| | SCS | Symbol | CP for | | CP for | |
|---|---|---|---|---|---|---|
| Numer- | (kilo- | Duration | Long | Over- | Other | Over- |
| ology | hertz | (microseconds | Symbols | head | Symbols | head |
| (μ) | (KHz)) | (μs)) | (μs) | % | (μs) | % |
| 0 | 15 | 66.67 | 5.2 | 7.8 | 4.69 | 7 |
| 1 | 30 | 33.33 | 2.86 | 8.6 | 2.34 | 7 |
| 2 | 60 | 16.67 | 1.69 | 10.2 | 1.17 | 7 |
| 3 | 120 | 8.33 | 1.11 | 13.3 | 0.59 | 7 |
| 4 | 240 | 4.1711 | 0.81 | 19.5 | 0.29 | 7 |

In some examples (e.g., in sub-THz frequency bands), due to a dominant line-of-sight (LOS) path, the downlink transmissions 230 may have a relatively smaller CIR length (e.g., 5-10 nanoseconds (ns)) than some other frequency bands. Additionally, such sub-THz frequency bands may be associated with a high SCS (e.g., a 960 kHz SCS) to account for strong phase noise (PN) and complexity associated with performing large fast Fourier transforms (FFTs). Thus, a CP used by the network entity 105-a for such sub-THz frequency bands may be shorter than for other frequency bands (e.g., 74 nanoseconds (ns) for the 960 kHz example, as compared to 4.17 microseconds for the 240 kHz example) without increasing ISI.

However, the transmitter of the network entity 105-a may have one or more physical limitations which may be associated with longer CP lengths for some types of downlink transmissions 230. For example, the network entity 105-a may use some time during the CP to configure analog phase shifters (PSs) or power amplifiers (PAS). As an illustrative example, the network entity 105-a may use 90-110 ns during the CP (e.g., with a tolerance of 20 ns for switching between PSs mapped on a same chip) to configure the PSs and PAs.

Accordingly, techniques described herein may enable the network entity 105-a to use non-uniform or unbalanced CP between symbols of a slot (e.g., with possible different CP sizes per symbol). The non-uniform CP lengths may accordingly support both latency associated with the network entity 105-a configuring the transmitter and to support shorter CP lengths due to short CIR and high SCS for sub-THz frequency bands. For example, the network entity 105-a may use a first CP length for one or more symbols of the slot that are dedicated for one or more transmissions of a first transmission type and a second CP length for one or more symbols of the slot that are dedicated for one or more transmissions of a second transmission type (e.g., and one or more additional CP lengths for one or more additional symbols). In some examples, the network entity 105-a may use a normal (e.g., uniform) CP length for one or more initial access messages (e.g., random access channel (RACH) messages), for broadcast signaling, for SSB messages, etc.

In some examples, the non-uniform CP lengths may be based on (e.g., may be a function of) current channel conditions; radio frequency (RF) configuration of gain, PAs. PSs, etc.; or slot structures. In some examples, the slot structures may include PDSCH data transmissions on a first group of symbols and CSI-RS transmissions on a second group of symbols, PDSCH data transmissions time multiplexed with SSB transmissions, etc.

In some examples, the network entity 105-a or the UE 115-a may determine a relatively small (e.g., minimum) CP length associated with the downlink channel 205 as compared to the normal CP length. For example, the network entity 105-a may transmit one or more CSI-RSs 215 to the UE 115-a (e.g., using a normal CP length), and the UE 115-a may determine one or more channel conditions (e.g., CIR) using CSI-RS measurements. The UE 115-a may accordingly determine a small CP length associated with (e.g., longer than or a same size as) the CIR, and may transmit a CSI-RS report 220 to the network entity 105-a indicating the small CP length. In some examples, the UE 115-a may transmit one or more SRSs 225 to the network entity 105-a. The network entity 105-a may determine one or more channel conditions (e.g., CIR) using SRS measurements, and may determine a small CP length associated with the CIR (and a reciprocity assumption, backoff, etc.). The network entity 105-a may indicate the small CP length to the UE 115-a. The network entity 105-a may accordingly apply the small CP length to one or more downlink transmissions 230 based on the CIR (e.g., and on or more analog capabilities of the network entity 105-a).

In some examples, one or both of the UE 115-a and the network entity 105-a may be configured with one or more CP size patterns. For example, the network entity 105-a may transmit a control message (e.g., a radio resource control (RRC) message) configuring the UE 115-a with a set of CP size patterns. The set of CP size patterns may indicate sets of symbols within a slot that may have a same CP length. For example, a CP size pattern of the set of CP size patterns may indicate a first CP length for a first group of symbols, a second CP length for a second group of symbols, and so on. The network entity 105-a may indicate (e.g., down-select) a pattern from the set of CP size patterns for the network entity 105-a and UE 115-a to apply (e.g., via DCI or MAC-CE signaling). The network entity 105-a may, additionally, or alternatively, indicate one or more symbols belonging to the first group of symbols, one or more symbols belonging to the second group of symbols, and so on. Accordingly, the network entity 105-a may dynamically configure the symbol groups sharing CP sizes within a specific slot template.

Additionally, or alternatively, the network entity 105-a may configure the UE 115-a with a set CP length templates (e.g., via RRC). The network entity 105-a may indicate (e.g., down-select) a CP length template from the set of CP length templates (e.g., via DCI or MAC-CE signaling). In some examples, each CP length template of the set of CP length templates may be associated with a common slot configuration use case. For example, a first CP length template of the set of CP length templates may be associated with a first slot configuration, a second CP length template of the set of CP length templates may be associated with a second slot configuration, and so on. In some examples, the slot configurations may include slots with CSI-RS symbols that are time division multiplexed (TDM'ed) with PDSCH symbols, SSB symbols that are TDM'ed with PDSCH symbols, SSB symbols that are TDM'ed with CSI-RS symbols, or a special slot structure.

In some examples, the UE 115-a and the network entity 105-a may identify a configuration for increasing CP lengths when transitioning between types of symbols. For example, the network entity 105-a may use a first CP length for a first symbol type (e.g., PDSCH symbols) and a second CP length for a second symbol type (e.g., SSB symbols).

The UE 115-a may use the CP length templates or patterns to decode the downlink transmissions 230. For example, the UE 115-a may use the CP length templates or patterns to select one or more time domain samples of the downlink transmission 230 before performing a FFT on each OFDM symbol.

The techniques described herein may allow for the network entity 105-a to have more flexibility in determining CP length, which may enable the network entity 105-a to adapt to changing environments (e.g., changing channel conditions). The described techniques may additionally or alternatively increase spectral efficiency by reducing overhead used for CP while allowing the network entity 105-a to change beams or other RF parameters within a slot. The network entity 105-a may therefore account for channel dispersity when choosing beams and performing precoding and may select downlink channels 205 that may be associated with a shorter possible CP length.

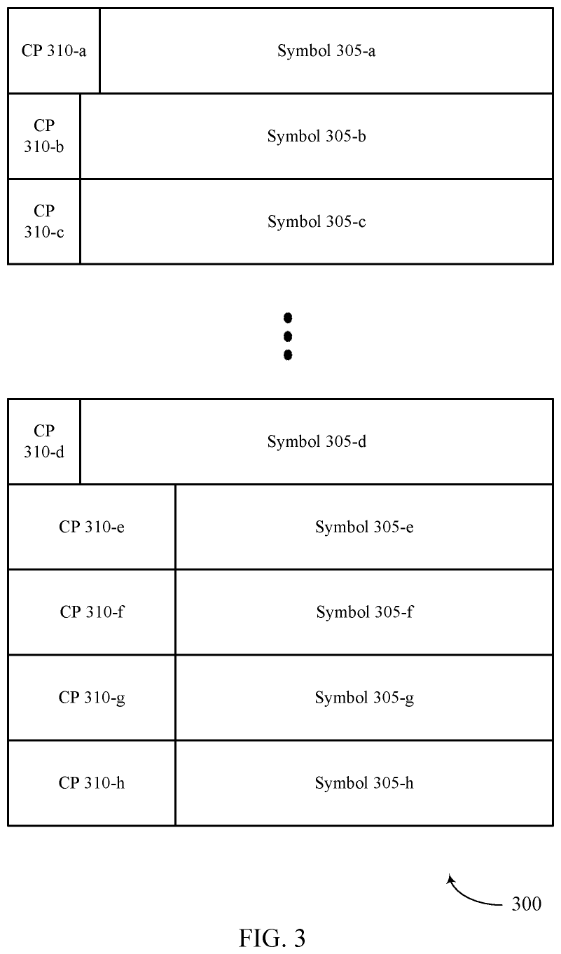

FIG. 3 shows an example of a slot diagram 300 that supports irregular CP lengths for downlink transmission in accordance with one or more aspects of the present disclosure. The slot diagram 300 may implement or may be implemented by aspects of the wireless communications system 100 or the wireless communications system 200. For example, the slot diagram 300 may be implemented by a UE 115 and a network entity 105, which may be examples of the corresponding devices as described herein with reference to FIG. 1.

According to techniques described herein, a network entity 105 may apply one or more different lengths of CP to one or more symbols of a slot for downlink transmissions to a UE 115. As an illustrative example, as illustrated with reference to FIG. 3, the network entity 105-a may determine to use a first CP length for a CP 310-a in a symbol 305-a. The network entity 105 may determine to use a second CP length for a CP 310-b, a CP 310-c, and a CP 310-d (e.g., and one or more additional CPs 310) in a symbol 305-b, a symbol 305-c, and a symbol 305-d (e.g., and one or more additional symbols 305), respectively. The network entity 105 may determine to use a third CP length for a CP 310-e, a CP 310-f, a CP 310-g, and a CP 310-h in a symbol 305-e, a symbol 305-f, a symbol 305-g, and a symbol 305-h, respectively.

In some examples, the network entity 105 may change beams for some types of transmissions (e.g., CSI-RSs or SSBs). For example, during a P2 beam refinement procedure, the network entity 105 may use different CSI-RSs in symbols 305 that have different spatial directions (e.g., while the UE 115 measures the CSI-RSs using a same receive beam). Thus, the network entity 105 may change beams between each symbol dedicated for CSI-RS. The network entity 105-a may therefore use a longer CP length (e.g., the third CP length) in one or more symbols dedicated for CSI-RSs for beam management (BM) or for SSBs to account for a beam switching delay. During a P3 beam refinement procedure, the network entity 105-a may switch beams once during a slot, and may therefore use a longer CP (e.g., the third CP length) in one symbol of the slot.

In some examples, the network entity 105 may transmit PDSCH transmissions on a first group of symbols 305 of the slot (e.g., the symbol 305-a through the symbol 305-d). The network entity 105 may use a same transmit beam for each of the PDSCH dedicated symbols 305. In some examples, the network entity 105-a may configure the beam during the CP 310-a. Accordingly, the first CP length may be longer than the second CP length (e.g., to account for a delay associated with configuring the beam), and the second CP length may be shorter than the third CP length. The second CP length may be based on a CIR of a channel between the UE 115 and the network entity 105 (e.g., determined from one or more CSI-RS or SRS measurements).

In some examples, each of the symbols 305 of the slot may have a same total length (e.g., including the CP lengths). Alternatively, the symbol 305-e through the symbol 305-h that are associated with a longer CP length may be longer than the symbol 305-a through the symbol 305-d that are associated with a shorter CP length (e.g., although the overall slot time may remain the same).

Although certain symbols 305 associated with certain CP lengths are depicted with reference to FIG. 3, in some examples, the network entity 105 may use one or more other CP length patterns. For example, in some aspects, the CP 310-b through the CP 310-d may be longer than the CP 310-e through the CP 310-h. In some aspects, the network entity 105 may use more or less than three CP lengths in a slot. In some aspects, one or more symbols 305 may have a same CP length as one or more other symbols 305 that are non-contiguous.

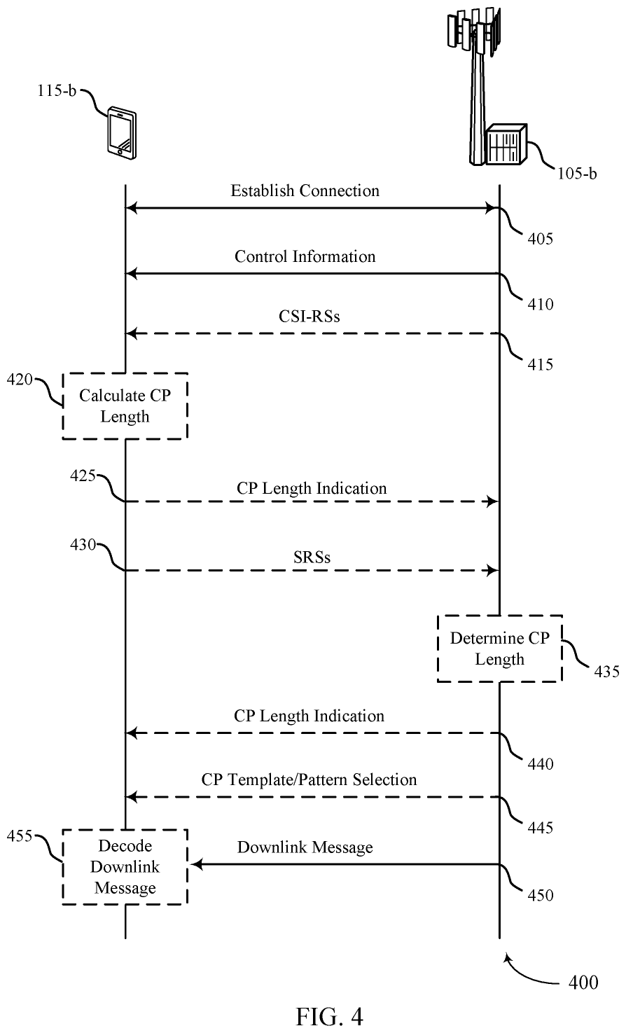

FIG. 4 shows an example of a process flow 400 that supports irregular CP lengths for downlink transmission in accordance with one or more aspects of the present disclosure. The process flow 400 may implement or may be implemented by aspects of the wireless communications system 100, the wireless communications system 200, or the slot diagram 300. For example, the process flow 400 may be implemented by a UE 115 (e.g., a UE 115-b) and a network entity 105 (e.g., a network entity 105-b), which may be examples of the corresponding devices as described herein with reference to FIG. 1.

In the following description of the process flow 400, the operations between the UE 115-b and the network entity 105-b may be transmitted in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the UE 115-b and the network entity 105-b may establish a connection. For example, the UE 115-b and the network entity 105-b may exchange one or more signals of a RACH procedure. The one or more signals may be associated with a uniform (e.g., normal) CP length.

At 410, the network entity 105-b may transmit control information to the UE 115-b. The control information may indicate that a plurality of symbols of a slot used for communication of a downlink message are associated with a non-uniform CP length. For example, the control information may indicate one or more non-uniform CP templates (e.g., each associated with a respective slot configuration of a plurality of slot configurations). The plurality of slot configurations may include a slot comprising some combination of CSI-RS symbols, SSB symbols, or PDSCH symbols, or a special slot. In some examples, the control information may indicate one or more non-uniform CP patterns. Each non-uniform CP pattern may indicate one or more groups of symbols of the slot that are each associated with a different CP length. For example, a first non-uniform CP pattern may indicate a first group of symbols associated with a first CP length and a second group of symbols associated with a second CP length. In some examples, the network entity 105-a may transmit the control information in a RRC message.

In some examples, at 415, the network entity 105-b may transmit one or more CSI-RSs to the UE 115-b via a channel between the network entity 105-b and the UE 115-b. The UE 115-b may measure the one or more CSI-RSs and, at 420, the UE 115-b may calculate a small (e.g., minimum) CP length for the downlink message (e.g., based on a CIR of the channel determined from the CSI-RSs). In some examples, at 425, the UE 115-b may transmit an indication of the small CP length to the network entity 105-b.

In some examples, at 430, the UE 115-b may transmit one or more SRSs to the network entity 105-b via the channel between the network entity 105-b and the UE 115-b. The network entity 105-b may measure the one or more SRSs and, at 435, the network entity 105-b may calculate the small CP length for the downlink message (e.g., based on a CIR of the channel determined from the SRSs). In some examples, at 440, the UE 115-b may receive an indication of the small CP length from the network entity 105-b.

In some examples, at 445, the network entity 105-b may transmit a control message (e.g., a MAC-CE message or a DCI message) to the UE 115-b indicating a CP template or a CP pattern of the one or more non-uniform CP templates or the one or more non-uniform CP patterns.

At 450, the network entity 105-b may transmit the downlink message to the UE 115-b during the slot. The network entity 105-b may transmit the downlink message based on the non-uniform CP lengths associated with the plurality of symbols of the slot. For example, a first symbol of the slot may have a first CP, and a second symbol of the slot may have a second CP (e.g., longer than the first CP). In some examples, the first symbol may be used to transmit a first type of transmission (e.g., a PDSCH transmission) and the second symbol may be used to transmit a second type of transmission (e.g., a CSI-RS or SSB).

In some examples, the network entity 105-b may transmit the downlink message according to one of the one or more non-uniform CP templates or the one or more non-uniform CP length patterns. For example, the first symbol may be part of the first symbol group, and the second symbol may be part of the second symbol group. In some examples, the first CP length may be the small CP length.

In some examples, one or more symbols of the slot may be associated with a longer CP to account for a beam configuration time of the network entity 105-b. For example, the second symbol or an initial symbol of the slot may be associated with a longer CP than the first CP to allow the network entity 105-b to configure one or more transmit beams (e.g., for one or more CSI-RSs, SSBs, or PDSCH transmissions). In some examples, the UE 115-b and the network entity 105-b may be configured to increase a CP length based at least in part on the first symbol being associated with a first transmission type (e.g., a PDSCH transmission) and the second symbol being associated with a second transmission type (e.g., a CSI-RS or SSB).

In some examples, at 455, the UE 115-b may decode the downlink message based on the non-uniform CP lengths. For example, the UE 115-b may select one or more time-domain samples of the downlink message based on the indicated non-uniform CP length template, the indicated non-uniform CP length pattern, or the indicated or calculated small CP length.

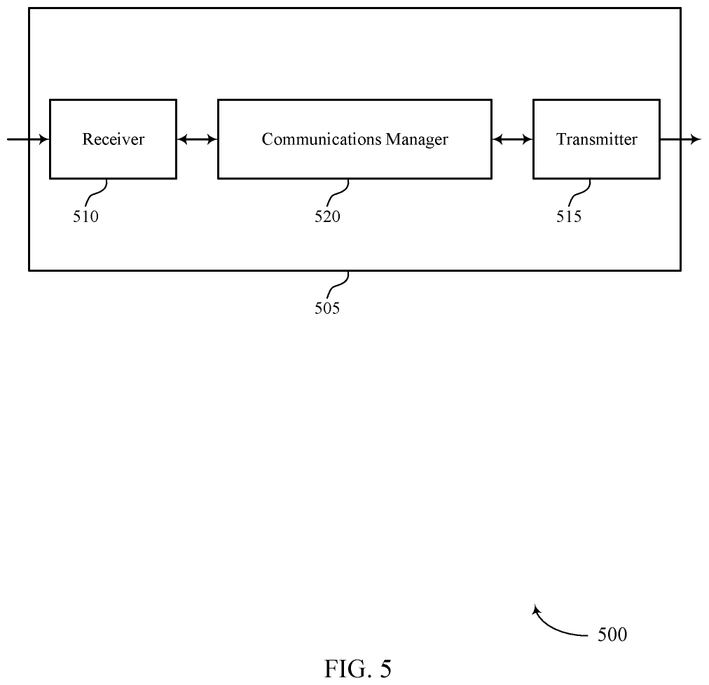

FIG. 5 shows a block diagram 500 of a device 505 that supports irregular CP lengths for downlink transmission in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor (not shown), which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to irregular CP lengths for downlink transmission). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to irregular CP lengths for downlink transmission). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of irregular CP lengths for downlink transmission as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (not shown) (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for establishing a connection with a network entity. The communications manager 520 is capable of, configured to, or operable to support a means for receiving control information indicating that a set of multiple symbols of a slot used for communication of a downlink message are associated with non-uniform CP lengths. The communications manager 520 is capable of, configured to, or operable to support a means for receiving the downlink message during the slot based on the non-uniform CP lengths associated with the set of multiple symbols of the slot, where a first cyclic prefix applied to a first symbol of the set of multiple symbols is shorter than a second cyclic prefix applied to a second symbol of the set of multiple symbols.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for irregular CP lengths for downlink transmissions, which may result in reduced signaling overhead.

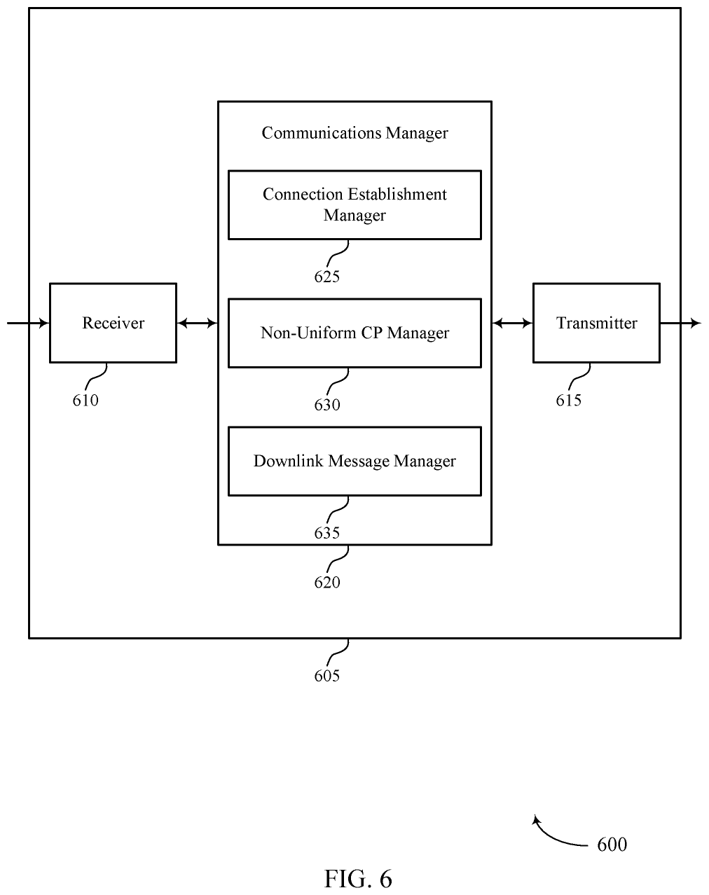

FIG. 6 shows a block diagram 600 of a device 605 that supports irregular CP lengths for downlink transmission in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor (not shown), which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to irregular CP lengths for downlink transmission). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to irregular CP lengths for downlink transmission). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of irregular CP lengths for downlink transmission as described herein. For example, the communications manager 620 may include a connection establishment manager 625, a non-uniform CP manager 630, a downlink message manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The connection establishment manager 625 is capable of, configured to, or operable to support a means for establishing a connection with a network entity. The non-uniform CP manager 630 is capable of, configured to, or operable to support a means for receiving control information indicating that a set of multiple symbols of a slot used for communication of a downlink message are associated with non-uniform CP lengths. The downlink message manager 635 is capable of, configured to, or operable to support a means for receiving the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

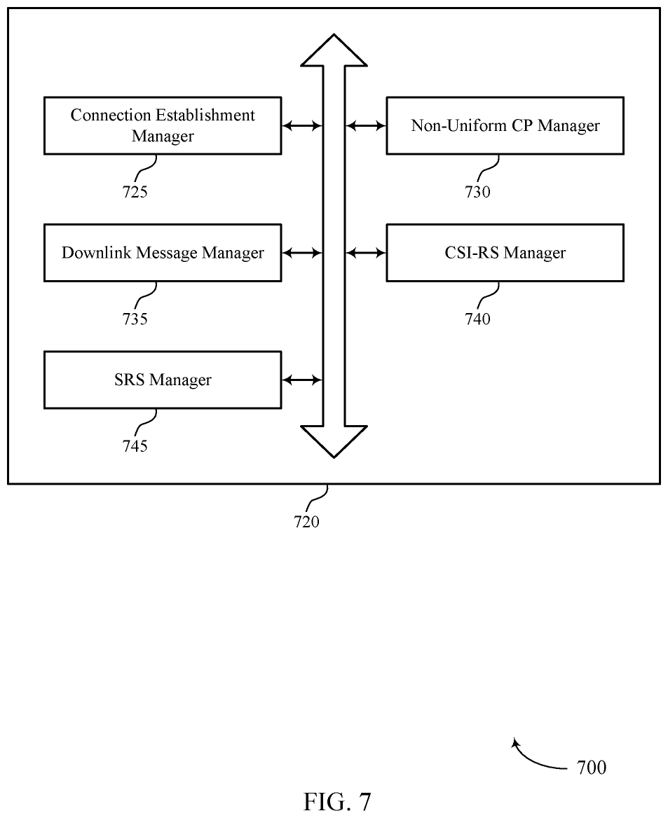

FIG. 7 shows a block diagram 700 of a communications manager 720 that supports irregular CP lengths for downlink transmission in accordance with one or more aspects of the present disclosure. The communications manager 720 may be an example of aspects of a communications manager 520, a communications manager 620, or both, as described herein. The communications manager 720, or various components thereof, may be an example of means for performing various aspects of irregular CP lengths for downlink transmission as described herein. For example, the communications manager 720 may include a connection establishment manager 725, a non-uniform CP manager 730, a downlink message manager 735, a CSI-RS manager 740, an SRS manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The connection establishment manager 725 is capable of, configured to, or operable to support a means for establishing a connection with a network entity. The non-uniform CP manager 730 is capable of, configured to, or operable to support a means for receiving control information indicating that a set of multiple symbols of a slot used for communication of a downlink message are associated with non-uniform CP lengths. The downlink message manager 735 is capable of, configured to, or operable to support a means for receiving the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

In some examples, the CSI-RS manager 740 is capable of, configured to, or operable to support a means for measuring one or more CSI-RSs via a channel between the UE and the network entity. In some examples, the non-uniform CP manager 730 is capable of, configured to, or operable to support a means for calculating, based on the measuring, a CP length for the downlink message associated with a CIR of the channel between the UE and the network entity.

In some examples, the SRS manager 745 is capable of, configured to, or operable to support a means for transmitting one or more SRSs via a channel between the UE and the network entity. In some examples, the non-uniform CP manager 730 is capable of, configured to, or operable to support a means for receiving, from the network entity, an indication of a CP length for the downlink message associated with a CIR of the channel between the UE and the network entity.

In some examples, to support receiving the control information, the non-uniform CP manager 730 is capable of, configured to, or operable to support a means for receiving a RRC message indicating one or more non-uniform CP templates, where each of the one or more non-uniform CP templates is associated with a respective slot configuration of a set of multiple slot configurations.

In some examples, the non-uniform CP manager 730 is capable of, configured to, or operable to support a means for receiving a control message indicating a non-uniform CP template of the one or more non-uniform CP templates.

In some examples, the control message is a MAC-CE or a DCI message.

In some examples, the set of multiple slot configurations includes a slot including one or more PDSCH symbols and one or more CSI-RS symbols, a slot including one or more PDSCH symbols and one or more SSB symbols, a slot including one or more CSI-RS symbols and one or more SSB symbols, a special slot, or some combination thereof.

In some examples, to support receiving the control information, the non-uniform CP manager 730 is capable of, configured to, or operable to support a means for receiving a control message indicating a set of multiple symbol groups of the slot, where the first symbol is in a first symbol group of the set of multiple symbol groups and where the second symbol is in a second symbol group of the set of multiple symbol groups.

In some examples, to support receiving the control information, the non-uniform CP manager 730 is capable of, configured to, or operable to support a means for receiving a RRC message indicating a set of multiple CP length patterns, where the control message indicates a CP length pattern of the set of multiple CP length patterns.

In some examples, the first symbol is a physical downlink shared channel symbol and the second symbol is one of a CSI-RS symbol or a SSB symbol.

In some examples, a length of the second CP is based on a beam configuration time for one or more channel state information reference signals.

In some examples, an initial symbol of the slot is associated with a longer CP than the first symbol. In some examples, a length of the initial symbol is based on a beam configuration time for one or more PDSCH transmissions.

In some examples, the UE is configured to increase a CP length based on the first symbol being associated with a first transmission type and the second symbol being associated with a second transmission type.

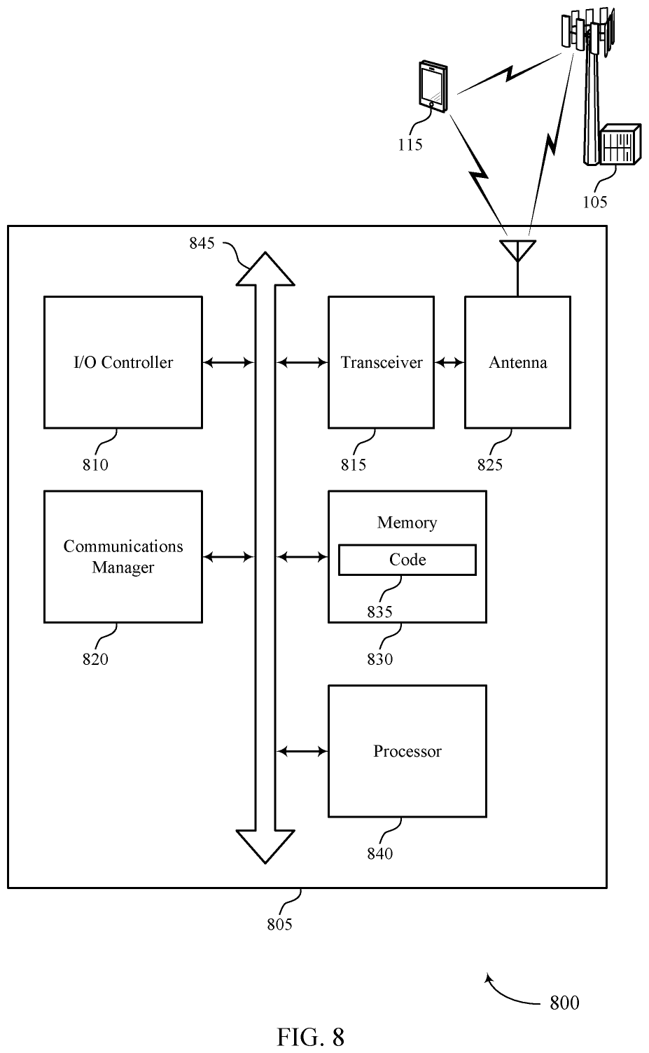

FIG. 8 shows a diagram of a system 800 including a device 805 that supports irregular CP lengths for downlink transmission in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors 840, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem (not shown) to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable or processor-executable code 835 including instructions that, when executed by the at least one processor 840, cause the device 805 to perform various functions described herein. The code 835 may be stored in a non-transitory computer-readable medium such as system memory 830 or another type of memory 830. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor 840, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory 830 (e.g., the at least one memory 830) to cause the device 805 to perform various functions (e.g., functions or tasks supporting irregular CP lengths for downlink transmission). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors 840 and the at least one memory 830 may include multiple memories 830. One or more of the multiple processors 840 may be coupled with one or more of the multiple memories 830, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for establishing a connection with a network entity. The communications manager 820 is capable of, configured to, or operable to support a means for receiving control information indicating that a set of multiple symbols of a slot used for communication of a downlink message are associated with non-uniform CP lengths. The communications manager 820 is capable of, configured to, or operable to support a means for receiving the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

By including or configuring the communications manager 820 in accordance with examples as described herein, the device 805 may support techniques for irregular CP lengths for downlink transmissions, which may result in improved communication reliability, improved coordination between devices, and reduced signaling overhead.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of irregular CP lengths for downlink transmission as described herein, or the at least one processor 840 and the at least one memory 830 may be otherwise configured to, individually or collectively, perform or support such operations.

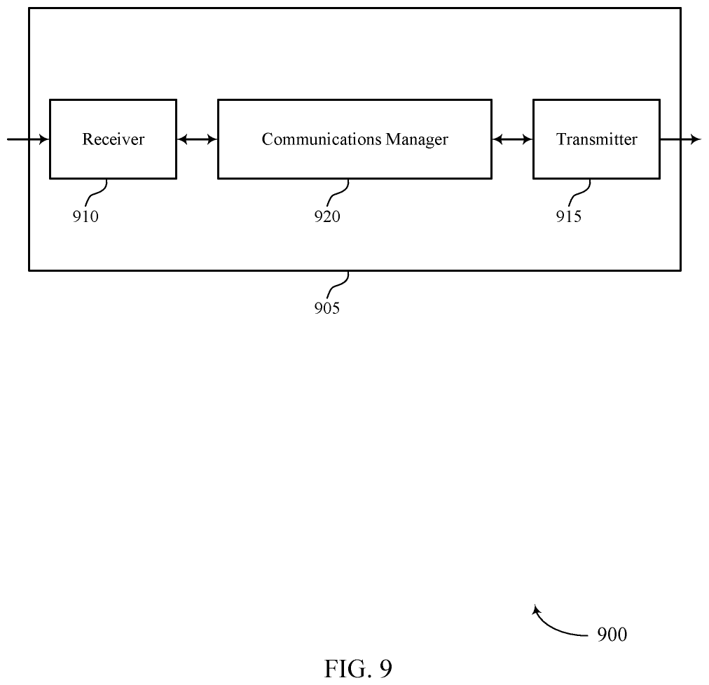

FIG. 9 shows a block diagram 900 of a device 905 that supports irregular CP lengths for downlink transmission in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor (not shown), which may be coupled with at least one memory 830, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem (not shown).

The communications manager 920, the receiver 910, the transmitter 915, or various combinations thereof or various components thereof may be examples of means for performing various aspects of irregular CP lengths for downlink transmission as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (not shown) (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for establishing a connection with a UE. The communications manager 920 is capable of, configured to, or operable to support a means for transmitting control information indicating that a set of multiple symbols of a slot used for communication of a downlink message are associated with non-uniform CP lengths. The communications manager 920 is capable of, configured to, or operable to support a means for transmitting the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for irregular CP lengths for downlink transmissions, which may result in reduced signaling overhead.

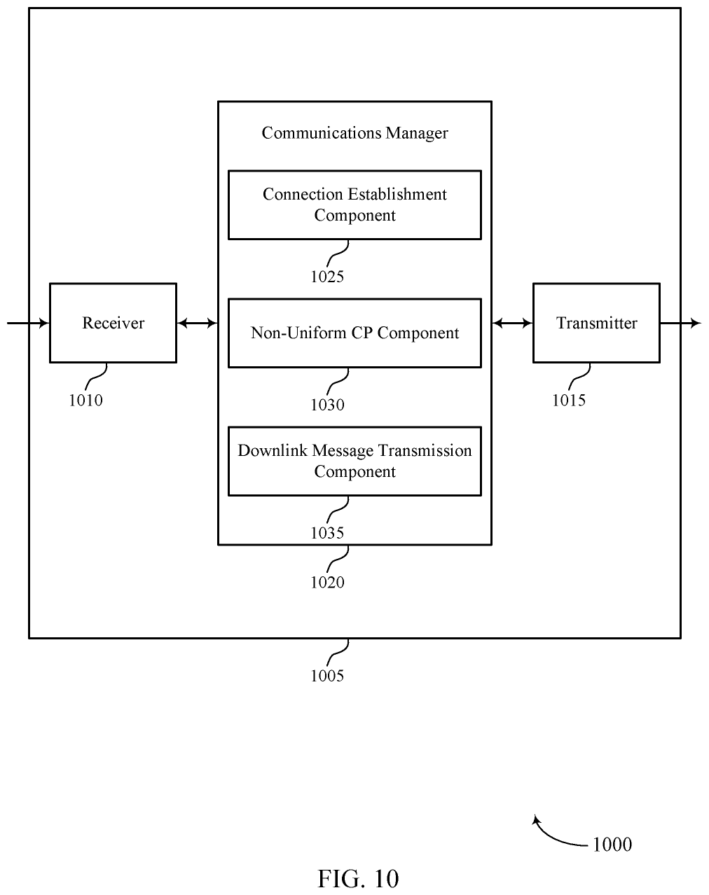

FIG. 10 shows a block diagram 1000 of a device 1005 that supports irregular CP lengths for downlink transmission in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor (not shown), which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem (not shown).

The device 1005, or various components thereof, may be an example of means for performing various aspects of irregular CP lengths for downlink transmission as described herein. For example, the communications manager 1020 may include a connection establishment component 1025, a non-uniform CP component 1030, a downlink message transmission component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The connection establishment component 1025 is capable of, configured to, or operable to support a means for establishing a connection with a UE. The non-uniform CP component 1030 is capable of, configured to, or operable to support a means for transmitting control information indicating that a set of multiple symbols of a slot used for communication of a downlink message are associated with non-uniform CP lengths. The downlink message transmission component 1035 is capable of, configured to, or operable to support a means for transmitting the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

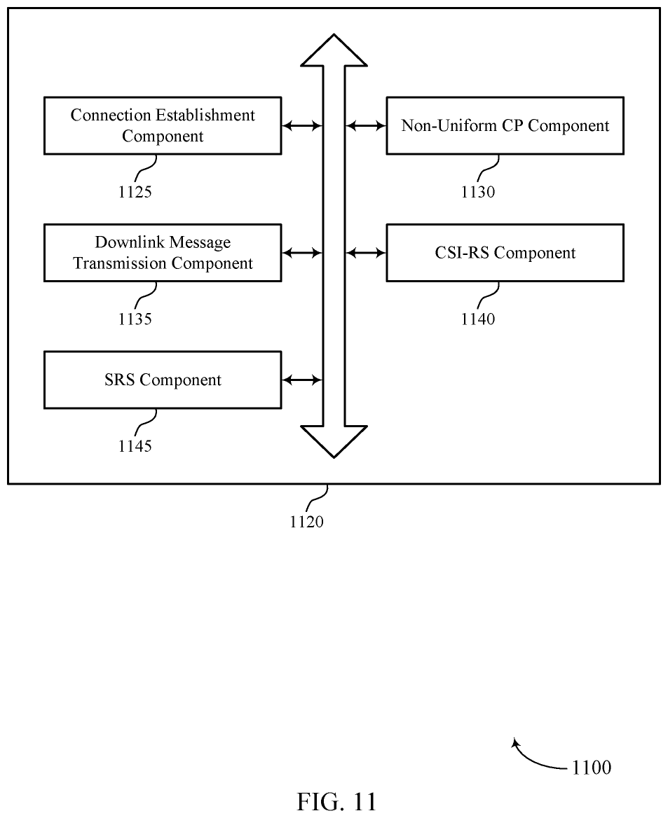

FIG. 11 shows a block diagram 1100 of a communications manager 1120 that supports irregular CP lengths for downlink transmission in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of irregular CP lengths for downlink transmission as described herein. For example, the communications manager 1120 may include a connection establishment component 1125, a non-uniform CP component 1130, a downlink message transmission component 1135, a CSI-RS component 1140, an SRS component 1145, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The connection establishment component 1125 is capable of, configured to, or operable to support a means for establishing a connection with a UE. The non-uniform CP component 1130 is capable of, configured to, or operable to support a means for transmitting control information indicating that a set of multiple symbols of a slot used for communication of a downlink message are associated with non-uniform CP lengths. The downlink message transmission component 1135 is capable of, configured to, or operable to support a means for transmitting the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

In some examples, the CSI-RS component 1140 is capable of, configured to, or operable to support a means for transmitting one or more CSI-RSs via a channel between the UE and the network entity. In some examples, the non-uniform CP component 1130 is capable of, configured to, or operable to support a means for receiving, from the UE, a CP length for the downlink message associated with a CIR of the channel between the UE and the network entity.

In some examples, the SRS component 1145 is capable of, configured to, or operable to support a means for measuring one or more SRSs via a channel between the UE and the network entity. In some examples, the non-uniform CP component 1130 is capable of, configured to, or operable to support a means for calculating, based on the measuring, an indication of a CP length for the downlink message associated with a CIR of the channel between the UE and the network entity.

In some examples, to support transmitting the control information, the non-uniform CP component 1130 is capable of, configured to, or operable to support a means for transmitting a RRC message indicating one or more non-uniform CP templates, where each of the one or more non-uniform CP templates is associated with a respective slot configuration of a set of multiple slot configurations.

In some examples, to support transmitting the control information, the non-uniform CP component 1130 is capable of, configured to, or operable to support a means for transmitting a control message indicating a non-uniform CP template of the one or more non-uniform CP templates.

In some examples, the control message is a MAC-CE or a DCI message.

In some examples, the set of multiple slot configurations includes a slot including one or more PDSCH symbols and one or more CSI-RS symbols, a slot including one or more PDSCH symbols and one or more SSB symbols, a slot including one or more CSI-RS symbols and one or more SSB symbols, a special slot, or some combination thereof.

In some examples, to support transmitting the control information, the non-uniform CP component 1130 is capable of, configured to, or operable to support a means for transmitting a control message indicating a set of multiple symbol groups of the slot, where the first symbol is in a first symbol group of the set of multiple symbol groups and where the second symbol is in a second symbol group of the set of multiple symbol groups.

In some examples, to support transmitting the control information, the non-uniform CP component 1130 is capable of, configured to, or operable to support a means for transmitting a RRC message indicating a set of multiple CP length patterns, where the control message indicates a CP length pattern of the set of multiple CP length patterns.

In some examples, the first symbol is a physical downlink shared channel symbol and the second symbol is one of a CSI-RS symbol or a SSB symbol.

In some examples, a length of the second CP is based on a beam configuration time for one or more channel state information reference signals.

In some examples, an initial symbol of the slot is associated with a longer CP than the first symbol. In some examples, a length of the initial symbol is based on a beam configuration time for one or more PDSCH transmissions.

In some examples, the network entity is configured to increase a CP length based on the first symbol being associated with a first transmission type and the second symbol being associated with a second transmission type.

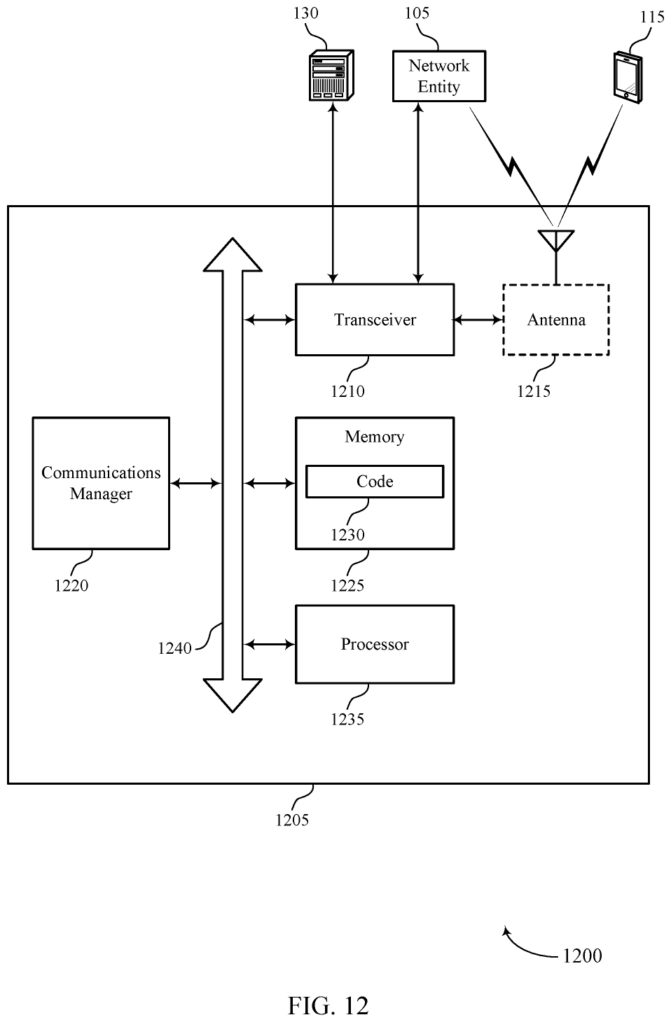

FIG. 12 shows a diagram of a system 1200 including a device 1205 that supports irregular CP lengths for downlink transmission in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem (not shown) to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors 1235 or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors 1235 or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory 1225 or another type of memory 1225. In some cases, the code 1230 may not be directly executable by a processor 1235 of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors 1235 and the at least one memory 1225 may include multiple memories 1225. One or more of the multiple processors 1235 may be coupled with one or more of the multiple memories 1225 which may, individually or collectively, be configured to perform various functions herein (for example, as part of a processing system).

The at least one processor 1235 may include an intelligent hardware device (e.g., a general-purpose processor 1235, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory 1225 (e.g., one or more of the at least one memory 1225) to cause the device 1205 to perform various functions (e.g., functions or tasks supporting irregular CP lengths for downlink transmission). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors 1235 capable of executing scripts or instructions of one or more software programs stored in the device 1205 (such as within one or more of the at least one memory 1225). In some examples, the at least one processor 1235 may include multiple processors 1235 and the at least one memory 1225 may include multiple memories 1225. One or more of the multiple processors may be coupled with one or more of the multiple memories 1225, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for establishing a connection with a UE. The communications manager 1220 is capable of, configured to, or operable to support a means for transmitting control information indicating that a set of multiple symbols of a slot used for communication of a downlink message are associated with non-uniform CP lengths. The communications manager 1220 is capable of, configured to, or operable to support a means for transmitting the downlink message during the slot based on the non-uniform CP lengths associated with the set of multiple symbols of the slot, where a first CP applied to a first symbol of the set of multiple symbols is shorter than a second CP applied to a second symbol of the set of multiple symbols.

By including or configuring the communications manager 1220 in accordance with examples as described herein, the device 1205 may support techniques for irregular CP lengths for downlink transmissions, which may result in improved communication reliability related to reduced interference, improved coordination between devices, and reduced signaling overhead.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include processor-executable instructions executable by one or more of the at least one processor 1235 to cause the device 1205 to perform various aspects of irregular CP lengths for downlink transmission as described herein, or the at least one processor 1235 and the at least one memory 1225 may be otherwise configured to, individually or collectively, perform or support such operations.

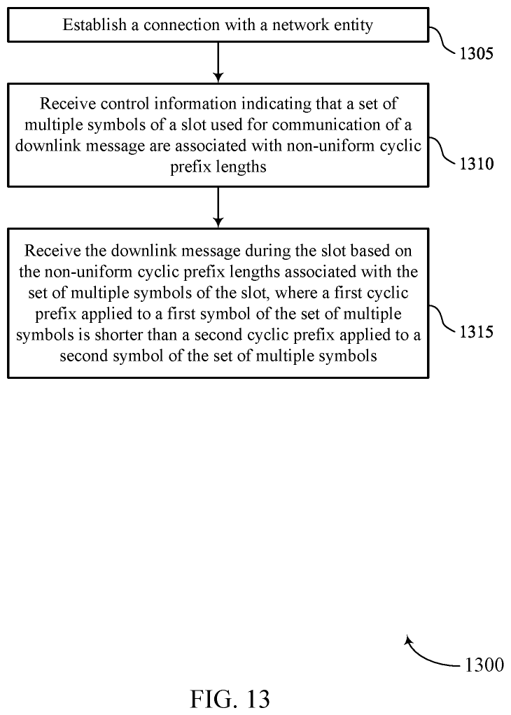

FIG. 13 shows a flowchart illustrating a method 1300 that supports irregular CP lengths for downlink transmission in accordance with aspects of the present disclosure. The operations of the method 1300 may be implemented by a UE or its components as described herein. For example, the operations of the method 1300 may be performed by a UE 115 as described herein with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include establishing a connection with a network entity. The operations of 1305 may be performed in accordance with examples as disclosed herein. In some examples, aspects of the operations of 1305 may be performed by a connection establishment manager 725 as described herein with reference to FIG. 7.

At 1310, the method may include receiving control information indicating that a set of multiple symbols of a slot used for communication of a downlink message are associated with non-uniform CP lengths. The operations of 1310 may be performed in accordance with examples as disclosed herein. In some examples, aspects of the operations of 1310 may be performed by a non-uniform CP manager 730 as described herein with reference to FIG. 7.

At 1315, the method may include receiving the downlink message during the slot based on the non-uniform CP lengths associated with the set of multiple symbols of the slot, where a first CP applied to a first symbol of the set of multiple symbols is shorter than a second CP applied to a second symbol of the set of multiple symbols. The operations of 1315 may be performed in accordance with examples as disclosed herein. In some examples, aspects of the operations of 1315 may be performed by a downlink message manager 735 as described herein with reference to FIG. 7.

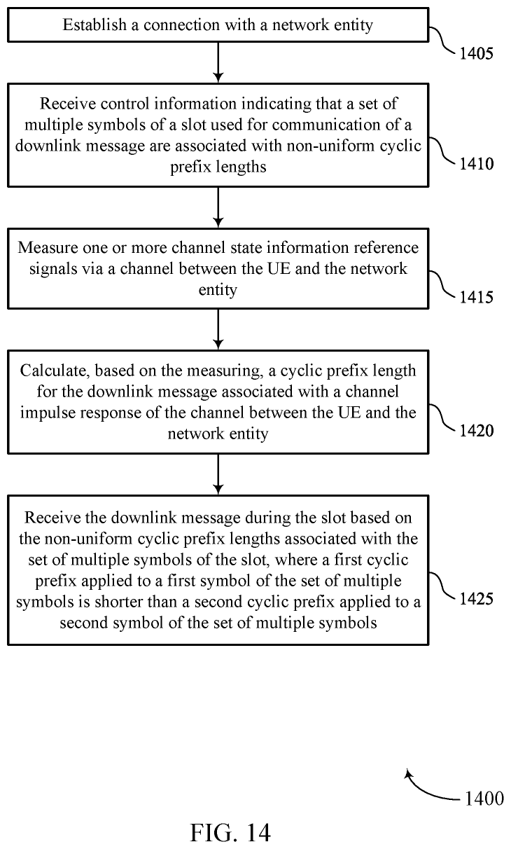

FIG. 14 shows a flowchart illustrating a method 1400 that supports irregular CP lengths for downlink transmission in accordance with aspects of the present disclosure. The operations of the method 1400 may be implemented by a UE or its components as described herein. For example, the operations of the method 1400 may be performed by a UE 115 as described herein with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include establishing a connection with a network entity. The operations of 1405 may be performed in accordance with examples as disclosed herein. In some examples, aspects of the operations of 1405 may be performed by a connection establishment manager 725 as described herein with reference to FIG. 7.

At 1410, the method may include receiving control information indicating that a set of multiple symbols of a slot used for communication of a downlink message are associated with non-uniform CP lengths. The operations of 1410 may be performed in accordance with examples as disclosed herein. In some examples, aspects of the operations of 1410 may be performed by a non-uniform CP manager 730 as described herein with reference to FIG. 7.

At 1415, the method may include measuring one or more CSI-RSs via a channel between the UE and the network entity. The operations of 1415 may be performed in accordance with examples as disclosed herein. In some examples, aspects of the operations of 1415 may be performed by a CSI-RS manager 740 as described herein with reference to FIG. 7.

At 1420, the method may include calculating, based on the measuring, a CP length for the downlink message associated with a CIR of the channel between the UE and the network entity. The operations of 1420 may be performed in accordance with examples as disclosed herein. In some examples, aspects of the operations of 1420 may be performed by a non-uniform CP manager 730 as described herein with reference to FIG. 7.

At 1425, the method may include receiving the downlink message during the slot based on the non-uniform CP lengths associated with the set of multiple symbols of the slot, where a first CP applied to a first symbol of the set of multiple symbols is shorter than a second CP applied to a second symbol of the set of multiple symbols. The operations of 1425 may be performed in accordance with examples as disclosed herein. In some examples, aspects of the operations of 1425 may be performed by a downlink message manager 735 as described herein with reference to FIG. 7.

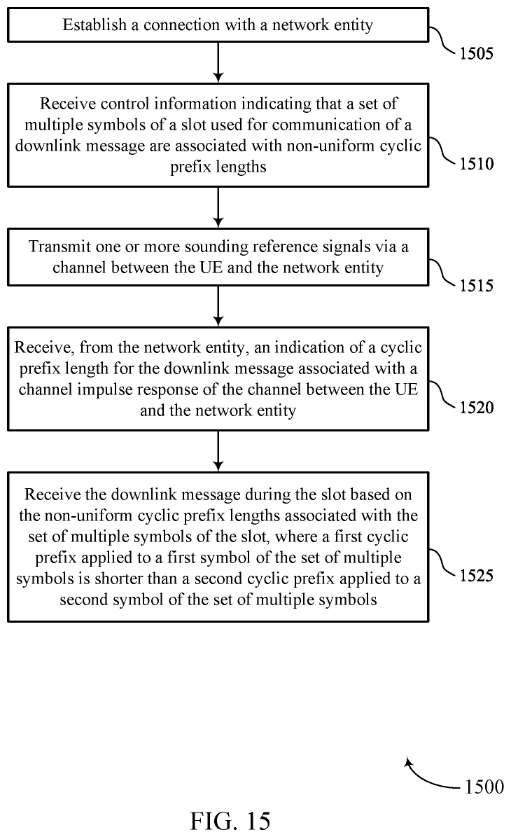

FIG. 15 shows a flowchart illustrating a method 1500 that supports irregular CP lengths for downlink transmission in accordance with aspects of the present disclosure. The operations of the method 1500 may be implemented by a UE or its components as described herein. For example, the operations of the method 1500 may be performed by a UE 115 as described herein with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include establishing a connection with a network entity. The operations of 1505 may be performed in accordance with examples as disclosed herein. In some examples, aspects of the operations of 1505 may be performed by a connection establishment manager 725 as described herein with reference to FIG. 7.

At 1510, the method may include receiving control information indicating that a set of multiple symbols of a slot used for communication of a downlink message are associated with non-uniform CP lengths. The operations of 1510 may be performed in accordance with examples as disclosed herein. In some examples, aspects of the operations of 1510 may be performed by a non-uniform CP manager 730 as described herein with reference to FIG. 7.

At 1515, the method may include transmitting one or more SRSs via a channel between the UE and the network entity. The operations of 1515 may be performed in accordance with examples as disclosed herein. In some examples, aspects of the operations of 1515 may be performed by an SRS manager 745 as described herein with reference to FIG. 7.

At 1520, the method may include receiving, from the network entity, an indication of a CP length for the downlink message associated with a CIR of the channel between the UE and the network entity. The operations of 1520 may be performed in accordance with examples as disclosed herein. In some examples, aspects of the operations of 1520 may be performed by a non-uniform CP manager 730 as described herein with reference to FIG. 7.

At 1525, the method may include receiving the downlink message during the slot based on the non-uniform CP lengths associated with the set of multiple symbols of the slot, where a first CP applied to a first symbol of the set of multiple symbols is shorter than a second CP applied to a second symbol of the set of multiple symbols. The operations of 1525 may be performed in accordance with examples as disclosed herein. In some examples, aspects of the operations of 1525 may be performed by a downlink message manager 735 as described herein with reference to FIG. 7.

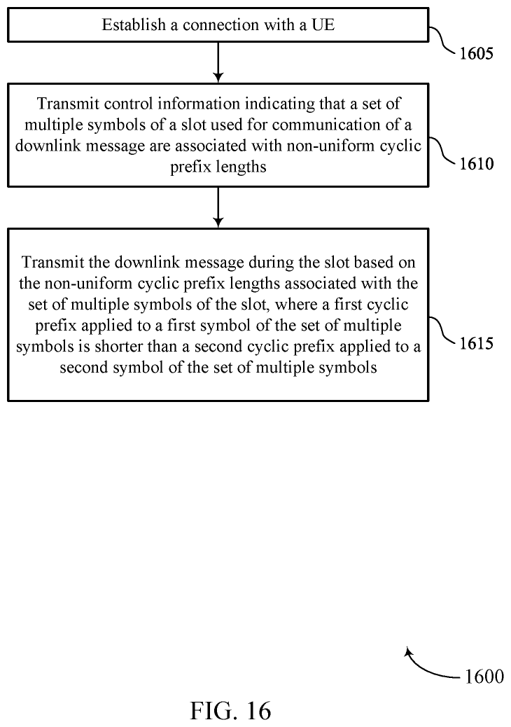

FIG. 16 shows a flowchart illustrating a method 1600 that supports irregular CP lengths for downlink transmission in accordance with aspects of the present disclosure. The operations of the method 1600 may be implemented by a network entity or its components as described herein. For example, the operations of the method 1600 may be performed by a network entity as described herein with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include establishing a connection with a UE. The operations of 1605 may be performed in accordance with examples as disclosed herein. In some examples, aspects of the operations of 1605 may be performed by a connection establishment component 1125 as described herein with reference to FIG. 11.

At 1610, the method may include transmitting control information indicating that a set of multiple symbols of a slot used for communication of a downlink message are associated with non-uniform CP lengths. The operations of 1610 may be performed in accordance with examples as disclosed herein. In some examples, aspects of the operations of 1610 may be performed by a non-uniform CP component 1130 as described herein with reference to FIG. 11.

At 1615, the method may include transmitting the downlink message during the slot based on the non-uniform CP lengths associated with the set of multiple symbols of the slot, where a first CP applied to a first symbol of the set of multiple symbols is shorter than a second CP applied to a second symbol of the set of multiple symbols. The operations of 1615 may be performed in accordance with examples as disclosed herein. In some examples, aspects of the operations of 1615 may be performed by a downlink message transmission component 1135 as described herein with reference to FIG. 11.

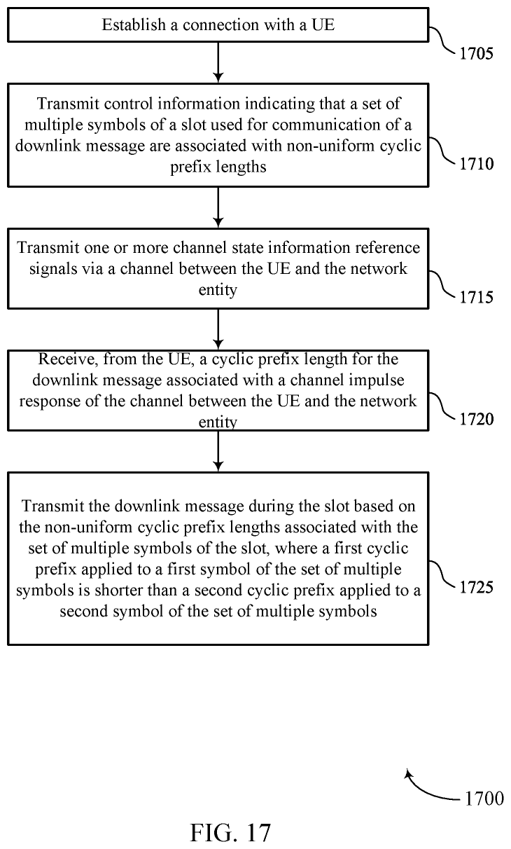

FIG. 17 shows a flowchart illustrating a method 1700 that supports irregular CP lengths for downlink transmission in accordance with aspects of the present disclosure. The operations of the method 1700 may be implemented by a network entity or its components as described herein. For example, the operations of the method 1700 may be performed by a network entity as described herein with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include establishing a connection with a UE. The operations of 1705 may be performed in accordance with examples as disclosed herein. In some examples, aspects of the operations of 1705 may be performed by a connection establishment component 1125 as described herein with reference to FIG. 11.

At 1710, the method may include transmitting control information indicating that a set of multiple symbols of a slot used for communication of a downlink message are associated with non-uniform CP lengths. The operations of 1710 may be performed in accordance with examples as disclosed herein. In some examples, aspects of the operations of 1710 may be performed by a non-uniform CP component 1130 as described herein with reference to FIG. 11.

At 1715, the method may include transmitting one or more CSI-RSs via a channel between the UE and the network entity. The operations of 1715 may be performed in accordance with examples as disclosed herein. In some examples, aspects of the operations of 1715 may be performed by a CSI-RS component 1140 as described with herein reference to FIG. 11.

At 1720, the method may include receiving, from the UE, a CP length for the downlink message associated with a CIR of the channel between the UE and the network entity. The operations of 1720 may be performed in accordance with examples as disclosed herein. In some examples, aspects of the operations of 1720 may be performed by a non-uniform CP component 1130 as described herein with reference to FIG. 11.

At 1725, the method may include transmitting the downlink message during the slot based on the non-uniform CP lengths associated with the set of multiple symbols of the slot, where a first CP applied to a first symbol of the set of multiple symbols is shorter than a second CP applied to a second symbol of the set of multiple symbols. The operations of 1725 may be performed in accordance with examples as disclosed herein. In some examples, aspects of the operations of 1725 may be performed by a downlink message transmission component 1135 as described herein with reference to FIG. 11.

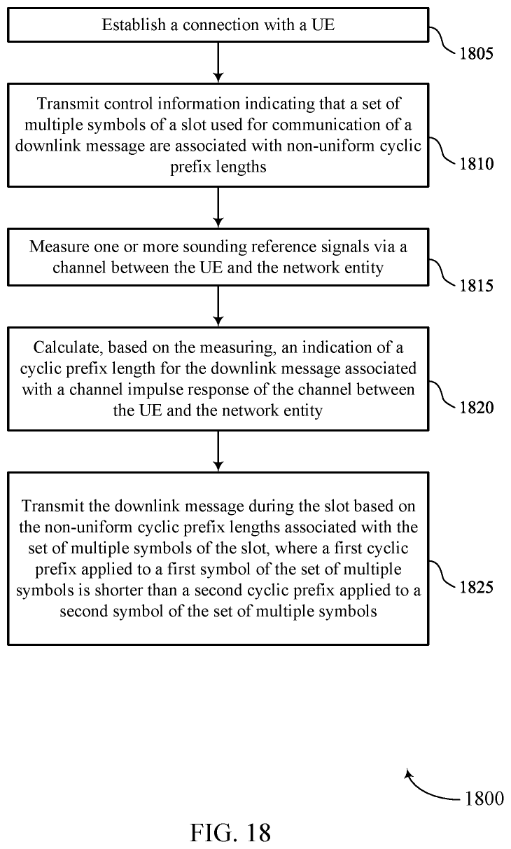

FIG. 18 shows a flowchart illustrating a method 1800 that supports irregular CP lengths for downlink transmission in accordance with aspects of the present disclosure. The operations of the method 1800 may be implemented by a network entity or its components as described herein. For example, the operations of the method 1800 may be performed by a network entity as described herein with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include establishing a connection with a UE. The operations of 1805 may be performed in accordance with examples as disclosed herein. In some examples, aspects of the operations of 1805 may be performed by a connection establishment component 1125 as described herein with reference to FIG. 11.

At 1810, the method may include transmitting control information indicating that a set of multiple symbols of a slot used for communication of a downlink message are associated with non-uniform CP lengths. The operations of 1810 may be performed in accordance with examples as disclosed herein. In some examples, aspects of the operations of 1810 may be performed by a non-uniform CP component 1130 as described herein with reference to FIG. 11.

At 1815, the method may include measuring one or more SRSs via a channel between the UE and the network entity. The operations of 1815 may be performed in accordance with examples as disclosed herein. In some examples, aspects of the operations of 1815 may be performed by an SRS component 1145 as described herein with reference to FIG. 11.

At 1820, the method may include calculating, based on the measuring, an indication of a CP length for the downlink message associated with a CIR of the channel between the UE and the network entity. The operations of 1820 may be performed in accordance with examples as disclosed herein. In some examples, aspects of the operations of 1820 may be performed by a non-uniform CP component 1130 as described herein with reference to FIG. 11.

At 1825, the method may include transmitting the downlink message during the slot based on the non-uniform CP lengths associated with the set of multiple symbols of the slot, where a first CP applied to a first symbol of the set of multiple symbols is shorter than a second CP applied to a second symbol of the set of multiple symbols. The operations of 1825 may be performed in accordance with examples as disclosed herein. In some examples, aspects of the operations of 1825 may be performed by a downlink message transmission component 1135 as described herein with reference to FIG. 11.

The following provides an overview of aspects of the present disclosure:

Aspect 1: A method for wireless communications by a UE, comprising: establishing a connection with a network entity; receiving control information indicating that a plurality of symbols of a slot used for communication of a downlink message are associated with non-uniform CP lengths; and receiving the downlink message during the slot based at least in part on the non-uniform CP lengths associated with the plurality of symbols of the slot, wherein a first CP applied to a first symbol of the plurality of symbols is shorter than a second CP applied to a second symbol of the plurality of symbols.

Aspect 2: The method of aspect 1, further comprising: measuring one or more CSI-RSs via a channel between the UE and the network entity; and calculating, based at least in part on the measuring, a CP length for the downlink message associated with a CIR of the channel between the UE and the network entity.

Aspect 3: The method of any of aspects 1 through 2, further comprising: transmitting one or more SRSs via a channel between the UE and the network entity; and receiving, from the network entity, an indication of a CP length for the downlink message associated with a CIR of the channel between the UE and the network entity.

Aspect 4: The method of any of aspects 1 through 3, wherein receiving the control information comprises: RRC message indicating one or more non-uniform CP templates, wherein each of the one or more non-uniform CP templates is associated with a respective slot configuration of a plurality of slot configurations.

Aspect 5: The method of aspect 4, further comprising: receiving a control message indicating a non-uniform CP template of the one or more non-uniform CP templates.

Aspect 6: The method of aspect 5, wherein the control message is a MAC-CE or a DCI message.

Aspect 7: The method of any of aspects 4 through 6, wherein the plurality of slot configurations comprises a slot comprising one or more PDSCH symbols and one or more CSI-RS symbols, a slot comprising one or more PDSCH symbols and one or more SSB symbols, a slot comprising one or more CSI-RS symbols and one or more SSB symbols, a special slot, or some combination thereof.

Aspect 8: The method of any of aspects 1 through 7, wherein receiving the control information comprises: receiving a control message indicating a plurality of symbol groups of the slot, wherein the first symbol is in a first symbol group of the plurality of symbol groups and wherein the second symbol is in a second symbol group of the plurality of symbol groups.

Aspect 9: The method of aspect 8, wherein receiving the control information comprises: receiving an RRC message indicating a plurality of CP length patterns, wherein the control message indicates a CP length pattern of the plurality of CP length patterns.

Aspect 10: The method of any of aspects 1 through 9, wherein the first symbol is a PDSCH symbol and the second symbol is one of a CSI-RS symbol or a SSB symbol.

Aspect 11: The method of aspect 10, wherein a length of the second CP is based at least in part on a beam configuration time for one or more CSI-RSs.

Aspect 12: The method of any of aspects 1 through 11, wherein an initial symbol of the slot is associated with a longer CP than the first symbol, and a length of the initial symbol is based at least in part on a beam configuration time for one or more PDSCH transmissions.

Aspect 13: The method of any of aspects 1 through 12, wherein the UE is configured to increase a CP length based at least in part on the first symbol being associated with a first transmission type and the second symbol being associated with a second transmission type.

Aspect 14: A method for wireless communications by a network entity, comprising: establishing a connection with a UE; transmitting control information indicating that a plurality of symbols of a slot used for communication of a downlink message are associated with non-uniform CP lengths; and transmitting the downlink message during the slot based at least in part on the non-uniform CP lengths associated with the plurality of symbols of the slot, wherein a first CP applied to a first symbol of the plurality of symbols is shorter than a second CP applied to a second symbol of the plurality of symbols.

Aspect 15: The method of aspect 14, further comprising: transmitting one or more CSI-RSs via a channel between the UE and the network entity; and receiving, from the UE, a CP length for the downlink message associated with a CIR of the channel between the UE and the network entity.

Aspect 16: The method of any of aspects 14 through 15, further comprising: measuring one or more SRSs via a channel between the UE and the network entity; and calculating, based at least in part on the measuring, an indication of a CP length for the downlink message associated with a CIR of the channel between the UE and the network entity.

Aspect 17: The method of any of aspects 14 through 16, wherein transmitting the control information comprises: transmitting a RRC message indicating one or more non-uniform CP templates, wherein each of the one or more non-uniform CP templates is associated with a respective slot configuration of a plurality of slot configurations.

Aspect 18: The method of aspect 17, wherein transmitting the control information comprises: transmitting a control message indicating a non-uniform CP template of the one or more non-uniform CP templates.

Aspect 19: The method of aspect 18, wherein the control message is a MAC-CE or a DCI message.

Aspect 20: The method of any of aspects 17 through 19, wherein the plurality of slot configurations comprises a slot comprising one or more PDSCH symbols and one or more CSI-RS symbols, a slot comprising one or more PDSCH symbols and one or more SSB symbols, a slot comprising one or more CSI-RS symbols and one or more SSB symbols, a special slot, or some combination thereof.

Aspect 21: The method of any of aspects 14 through 20, wherein transmitting the control information comprises: transmitting a control message indicating a plurality of symbol groups of the slot, wherein the first symbol is in a first symbol group of the plurality of symbol groups and wherein the second symbol is in a second symbol group of the plurality of symbol groups.

Aspect 22: The method of aspect 21, wherein transmitting the control information comprises: transmitting a RRC message indicating a plurality of CP length patterns, wherein the control message indicates a CP length pattern of the plurality of CP length patterns.

Aspect 23: The method of any of aspects 14 through 22, wherein the first symbol is a PDSCH symbol and the second symbol is one of a CSI-RS symbol or a SSB symbol.

Aspect 24: The method of aspect 23, wherein a length of the second CP is based at least in part on a beam configuration time for one or more CSI-RSs.

Aspect 25: The method of any of aspects 14 through 24, wherein an initial symbol of the slot is associated with a longer CP than the first symbol, and a length of the initial symbol is based at least in part on a beam configuration time for one or more PDSCH transmissions.

Aspect 26: The method of any of aspects 14 through 25, wherein the network entity is configured to increase a CP length based at least in part on the first symbol being associated with a first transmission type and the second symbol being associated with a second transmission type.

Aspect 27: A UE for wireless communications, comprising one or more memories storing processor-executable code, and one or more processors coupled with the one or more memories and individually or collectively operable to execute the code to cause the UE to perform a method of any of aspects 1 through 13.

Aspect 28: A UE for wireless communications, comprising at least one means for performing a method of any of aspects 1 through 13.

Aspect 29: A non-transitory computer-readable medium storing code for wireless communications, the code comprising instructions executable by a processor to perform a method of any of aspects 1 through 13.

Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.

Aspect 31: A network entity for wireless communications, comprising at least one means for performing a method of any of aspects 14 through 26.

Aspect 32: A non-transitory computer-readable medium storing code for wireless communications, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
establish a connection with a network entity;
receive control information indicating that a plurality of symbols of a slot used for communication of a downlink message are associated with non-uniform cyclic prefix lengths; and
receive the downlink message during the slot based at least in part on the non-uniform cyclic prefix lengths associated with the plurality of symbols of the slot, wherein a first cyclic prefix applied to a first symbol of the plurality of symbols is shorter than a second cyclic prefix applied to a second symbol of the plurality of symbols.

2. The UE of claim 1, wherein the one or more processors are individually or collectively further operable to execute the code to cause the UE to:
measure one or more channel state information reference signals via a channel between the UE and the network entity; and
calculate, based at least in part on the measuring, a cyclic prefix length for the downlink message associated with a channel impulse response of the channel between the UE and the network entity.

3. The UE of claim 1, wherein the one or more processors are individually or collectively further operable to execute the code to cause the UE to:
transmit one or more sounding reference signals via a channel between the UE and the network entity; and
receive, from the network entity, an indication of a cyclic prefix length for the downlink message associated with a channel impulse response of the channel between the UE and the network entity.

4. The UE of claim 1, wherein, to receive the control information, the one or more processors are individually or collectively operable to execute the code to cause the UE to:
receive a radio resource control message indicating one or more non-uniform cyclic prefix templates, wherein each of the one or more non-uniform cyclic prefix templates is associated with a respective slot configuration of a plurality of slot configurations.

5. The UE of claim 4, wherein the one or more processors are individually or collectively further operable to execute the code to cause the UE to:
receive a control message indicating a non-uniform cyclic prefix template of the one or more non-uniform cyclic prefix templates.

6. The UE of claim 5, wherein the control message is a medium access control control element or a downlink control information message.

7. The UE of claim 4, wherein the plurality of slot configurations comprises a slot comprising one or more physical downlink shared channel symbols and one or more channel state information reference signal symbols, a slot comprising one or more physical downlink shared channel symbols and one or more synchronization signal block symbols, a slot comprising one or more channel state information reference signal symbols and one or more synchronization signal block symbols, a special slot, or some combination thereof.

8. The UE of claim 1, wherein, to receive the control information, the one or more processors are individually or collectively operable to execute the code to cause the UE to:
receive a control message indicating a plurality of symbol groups of the slot, wherein the first symbol is in a first symbol group of the plurality of symbol groups and wherein the second symbol is in a second symbol group of the plurality of symbol groups.

9. The UE of claim 8, wherein, to receive the control information, the one or more processors are individually or collectively operable to execute the code to cause the UE to:
receive a radio resource control message indicating a plurality of cyclic prefix length patterns, wherein the control message indicates a cyclic prefix length pattern of the plurality of cyclic prefix length patterns.

10. The UE of claim 1, wherein the first symbol is a physical downlink shared channel symbol and the second symbol is one of a channel state information reference signal symbol or a synchronization signal block symbol.

11. The UE of claim 10, wherein a length of the second cyclic prefix is based at least in part on a beam configuration time for one or more channel state information reference signals.

12. The UE of claim 1, wherein an initial symbol of the slot is associated with a longer cyclic prefix than the first symbol, and wherein a length of the initial symbol is based at least in part on a beam configuration time for one or more physical downlink shared channel transmissions.

13. The UE of claim 1, wherein the UE is configured to increase a cyclic prefix length based at least in part on the first symbol being associated with a first transmission type and the second symbol being associated with a second transmission type.

14. A network entity, comprising:
one or more memories storing processor-executable code; and
one or more processors coupled with the one or more memories and individually or collectively operable to execute the code to cause the network entity to:
establish a connection with a user equipment (UE);
transmit control information indicating that a plurality of symbols of a slot used for communication of a downlink message are associated with non-uniform cyclic prefix lengths; and
transmit the downlink message during the slot based at least in part on the non-uniform cyclic prefix lengths associated with the plurality of symbols of the slot, wherein a first cyclic prefix applied to a first symbol of the plurality of symbols is shorter than a second cyclic prefix applied to a second symbol of the plurality of symbols.

15. The network entity of claim 14, wherein the one or more processors are individually or collectively further operable to execute the code to cause the network entity to:
transmit one or more channel state information reference signals via a channel between the UE and the network entity; and
receive, from the UE, a cyclic prefix length for the downlink message associated with a channel impulse response of the channel between the UE and the network entity.

16. The network entity of claim 14, wherein the one or more processors are individually or collectively further operable to execute the code to cause the network entity to:
measure one or more sounding reference signals via a channel between the UE and the network entity; and
calculate, based at least in part on the measuring, an indication of a cyclic prefix length for the downlink message associated with a channel impulse response of the channel between the UE and the network entity.

17. The network entity of claim 14, wherein, to transmit the control information, the one or more processors are individually or collectively operable to execute the code to cause the network entity to:
transmit a radio resource control message indicating one or more non-uniform cyclic prefix templates, wherein each of the one or more non-uniform cyclic prefix templates is associated with a respective slot configuration of a plurality of slot configurations.

18. The network entity of claim 17, wherein, to transmit the control information, the one or more processors are individually or collectively operable to execute the code to cause the network entity to:
transmit a control message indicating a non-uniform cyclic prefix template of the one or more non-uniform cyclic prefix templates.

19. The network entity of claim 18, wherein the control message is a medium access control control element or a downlink control information message.

20. The network entity of claim 17, wherein the plurality of slot configurations comprises a slot comprising one or more physical downlink shared channel symbols and one or more channel state information reference signal symbols, a slot comprising one or more physical downlink shared channel symbols and one or more synchronization signal block symbols, a slot comprising one or more channel state information reference signal symbols and one or more synchronization signal block symbols, a special slot, or some combination thereof.

21. The network entity of claim 14, wherein, to transmit the control information, the one or more processors are individually or collectively operable to execute the code to cause the network entity to:
transmit a control message indicating a plurality of symbol groups of the slot, wherein the first symbol is in a first symbol group of the plurality of symbol groups and wherein the second symbol is in a second symbol group of the plurality of symbol groups.

22. The network entity of claim 21, wherein, to transmit the control information, the one or more processors are individually or collectively operable to execute the code to cause the network entity to:
transmit a radio resource control message indicating a plurality of cyclic prefix length patterns, wherein the control message indicates a cyclic prefix length pattern of the plurality of cyclic prefix length patterns.

23. The network entity of claim 14, wherein the first symbol is a physical downlink shared channel symbol and the second symbol is one of a channel state information reference signal symbol or a synchronization signal block symbol.

24. The network entity of claim 23, wherein a length of the second cyclic prefix is based at least in part on a beam configuration time for one or more channel state information reference signals.

25. The network entity of claim 14, wherein an initial symbol of the slot is associated with a longer cyclic prefix than the first symbol, and wherein a length of the initial symbol is based at least in part on a beam configuration time for one or more physical downlink shared channel transmissions.

26. The network entity of claim 14, wherein the network entity is configured to increase a cyclic prefix length based at least in part on the first symbol being associated with a first transmission type and the second symbol being associated with a second transmission type.

27. A method for wireless communications by a user equipment (UE), comprising:
establishing a connection with a network entity;
receiving control information indicating that a plurality of symbols of a slot used for communication of a downlink message are associated with non-uniform cyclic prefix lengths; and
receiving the downlink message during the slot based at least in part on the non-uniform cyclic prefix lengths associated with the plurality of symbols of the slot, wherein a first cyclic prefix applied to a first symbol of the plurality of symbols is shorter than a second cyclic prefix applied to a second symbol of the plurality of symbols.

28. The method of claim 27, further comprising:
measuring one or more channel state information reference signals via a channel between the UE and the network entity; and
calculating, based at least in part on the measuring, a cyclic prefix length for the downlink message associated with a channel impulse response of the channel between the UE and the network entity.

29. A method for wireless communications by a network entity, comprising:
establishing a connection with a user equipment (UE);
transmitting control information indicating that a plurality of symbols of a slot used for communication of a downlink message are associated with non-uniform cyclic prefix lengths; and
transmitting the downlink message during the slot based at least in part on the non-uniform cyclic prefix lengths associated with the plurality of symbols of the slot, wherein a first cyclic prefix applied to a first symbol of the plurality of symbols is shorter than a second cyclic prefix applied to a second symbol of the plurality of symbols.

30. The method of claim 29, further comprising:
transmitting one or more channel state information reference signals via a channel between the UE and the network entity; and
receiving, from the UE, a cyclic prefix length for the downlink message associated with a channel impulse response of the channel between the UE and the network entity.
